(19) United States
(12) Patent Application Publication
(10) Pub. No.: US 2017/0262900 A1
(43) Pub. Date: Sep. 14, 2017

(54) SYSTEM AND METHOD FOR GENERATING PROMOTION DATA

(71) Applicant: Wipro Limited, Bangalore (IN)

(72) Inventors: Saju RAMACHANDRAN, Bangalore (IN); Sanjay BHASKARAPPA, Bangalore (IN); Babu Reddy HANUMANTHA, Bangalore (IN)

(73) Assignee: Wipro Limited

(21) Appl. No.: 15/087,480

(22) Filed: Mar. 31, 2016

(30) Foreign Application Priority Data
Mar. 11, 2016 (IN) 201641008601

(51) Int. Cl. G06Q 30/02; G06N 99/00; G06Q 10/06

(52) U.S. Cl. CPC G06Q 30/0276; G06Q 30/0202; G06Q 10/067; G06N 99/005

(57) ABSTRACT

System and method for generating promotion data for at least one product are disclosed. The method comprises receiving input data from a plurality of data sources and identifying training data by analyzing the input data based on several linearity factors. The method further comprises creating a plurality of feature sets based on the training data and selecting an optimized feature set from the plurality of feature based on a regression model. The method further comprises ascertaining an uplift model for each of the at least one product based on the optimized feature set and determining a baseline volume and a predictive volume based on the uplift model. The method further comprises determining an uplift volume for each of the at least one product based on the baseline volume and the predictive volume. The method further comprises generating the promotion data based on promotional expenditure data and the uplift volume.

### TECHNICAL FIELD

This disclosure relates generally to analyzing product promotions and more particularly to a system and a method for generating promotion data for at least one product.

### BACKGROUND

These days market has been observing a massive increase in the launch of different products, such as fast moving consumer goods (FMCG) products. To boost sales of such products, many companies run promotional campaigns. Promotions in a promotional campaign might typically include giving discounts, increasing visibility of the products by putting them at strategic positions in shops or running television commercials. Typically, these promotional campaigns have a direct relationship with sales of the products. However, it is very difficult to keep track and to analyze promotions/commercials that have brought good Return on Investments (ROI). Also there is lot of difficulty in keep a track of the promotions that is to be retained to maintain or increase the sales. With each company running different promotions at the same time, it is very difficult for a particular company to analyze the industry trends and decide on specific promotion that was effective in the past and that might be effective in future.

In one conventional approach, various systems are used to generate promotion data to assess effectiveness of promotional campaigns. However, such systems may not be accurate as they perform the assessment at a manufacturer level or a retailer level. The conventional system considers cannibalization factors at a broader level and only known casuals while generating the promotion data which may hamper the accuracy of the promotion data.

### SUMMARY

In one embodiment, a method for generating promotion data for at least one product is disclosed. The method comprises receiving by a product promotion system, input data from a plurality of data sources, and the input data comprises of manufacturer data, retailer data and third party data. The method further comprises identifying by the product promotion system, training data by analyzing the input data based on several linearity factors. The method further comprises creating by the product promotion system, a plurality of feature sets based on the training data. The method further comprises selecting, by the product promotion system, an optimized feature set from the plurality of feature sets by applying a regression model to the plurality of feature sets. The method further comprises ascertaining, by the product promotion system, an uplift model for each of the at least one product based on the optimized feature set. The method further comprises determining, by the product promotion system, a baseline volume and a predictive volume based on the uplift model. The method further comprises determining, by the product promotion system, an uplift volume for each of the at least one product based on the baseline volume and the predictive volume. The method still further comprises generating, by the product promotion system, the promotion data based on promotional expenditure data and the uplift volume.

In another embodiment, a system for generating promotion data for at least one product is disclosed. The system includes at least one processors and a computer-readable medium. The computer-readable medium stores instructions that, when executed by the at least one processor, cause the at least one processor to perform operations comprising, receiving, input data from a plurality of data sources, and the input data comprises of manufacturer data, retailer data and third party data. The operation further comprising identifying, training data by analyzing the input data based on several linearity factors. The operation further comprising, creating, plurality of feature sets based on the training data. The operation further comprising, selecting, an optimized feature set from the plurality of feature sets by applying a regression model to the plurality of feature sets. The operation further comprising ascertaining, an uplift model for each of the at least one product based on the optimized feature set. The operation further comprising determining, a baseline volume and a predictive volume based on the uplift model. The operation further comprising determining, an uplift volume for each of the at least one product based on the baseline volume and the predictive volume. The operation still further comprising generating, the promotion data based on promotional expenditure data and the uplift volume.

In another embodiment, a non-transitory computer-readable storage medium for generating promotion data for at least one product is disclosed, which when executed by a computing device, cause the computing device to perform operations comprising receiving, input data from a plurality of data sources, and the input data comprises of manufacturer data, retailer data and third party data. The operation further comprising identifying, training data by analyzing the input data based on several linearity factors. The operation further comprising, creating, plurality of feature sets based on the training data. The operation further comprising, selecting, an optimized feature set from the plurality of feature sets by applying a regression model to the plurality of feature sets. The operation further comprising, ascertaining, an uplift model for each of the at least one product based on the optimized feature set. The operation further comprising determining, a baseline volume and a predictive volume based on the uplift model. The operation further comprising, determining, an uplift volume for each of the at least one product based on the baseline volume and the predictive volume. The operation still further comprising generating, the promotion data based on promotional expenditure data and the uplift volume.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network environment, comprising a product promotion system, in accordance with some embodiments of the present disclosure.

FIG. 2 illustrates an exemplary method for generating promotion data, in accordance with some embodiments of the present disclosure.

FIG. 3 illustrates an exemplary method generating predictive volume, in accordance with some embodiments of the present disclosure.

FIG. 4 illustrates an exemplary method generating baseline volume, in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

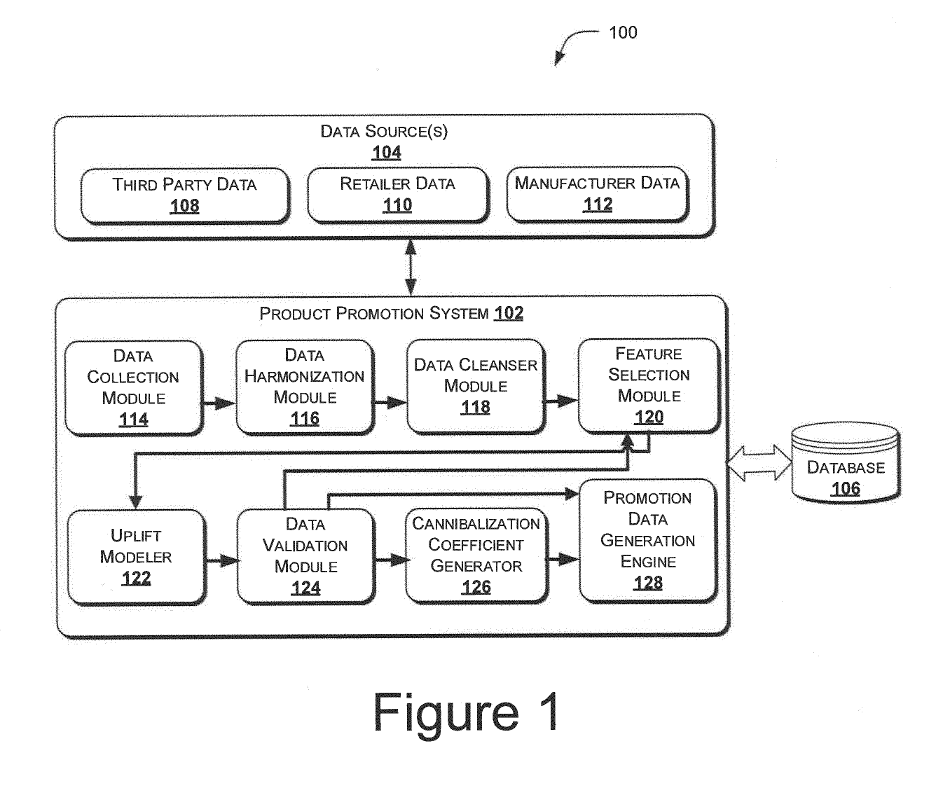

Working of the systems and methods for generating promotion data for products is described in conjunction with FIGS. 1-5. It should be noted that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates an exemplary network environment 100 comprising a product promotion system 102, in accordance with some embodiments of the present disclosure.

As shown in FIG. 1, the product promotion system 102 is communicatively coupled to data source(s) 104, and a database 106. The data source(s) 104 comprise third party data 108, retailer data 110, and manufacturer data 112. In an example, the third party data 108 may comprise details of similar competitor products. The details may include duration, type, and sales information of the competitor products. In an example, the details of the competitor products may be obtained from companies into market analytics or from companies to whom retailers of the competitive products may have sold their point-of-sales data. In an example, the retailer data 110 comprises point-of-sales data from the stores selling the products. In an example, the manufacturer data 112 may include historical sales data obtained from different stores selling products under consideration and promotion planning data planned for previous promotional activities and current promotional activity.

The database 106 comprises data generated by the product promotion system 102. In an example, the database 106 may store metadata of model definitions and coefficient obtained during the generation of promotion data. The metadata generated and stored may be then used for future reference. The product promotion system 102 may access the metadata from the database 106 whenever the product promotion data is to be generated.

Further, the product promotion system 102 may communicate to the data source(s) 104, and the database 106 through a network. The network may be a wireless network, wired network or a combination thereof. The network can be implemented as one of the different types of networks, such as intranet, local area network (LAN), wide area network (WAN), the internet, and such. The network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network may include a variety of network devices, including routers, bridges, servers, computing devices, storage devices, etc.

For brevity, the product promotion system 102 may be interchangeably referred to as the system 102. The system 102 may be implemented on variety of computing systems. Examples of the computing systems may include a laptop computer, a desktop computer, a tablet, a notebook, a workstation, a mainframe computer, a server, a network server, and the like. Although the description herein is with reference to certain computing systems, the systems and methods may be implemented in other computing systems, albeit with a few variations, as will be understood by a person skilled in the art.

As shown in FIG. 1, the system 102 comprises a data collection module 114, a data harmonizer module 116, a data cleanser module 118, a feature selection module 120, an uplift modeler 122, a data validation module 124, a cannibalization coefficient generator 126 and a promotion data generation engine 128.

In operations, to generate the promotion data, the data collection module 114 may receive input data pertaining to at least one product from data source(s) 104. In an example, the input data comprise the manufacturer data 112, the retailer data 110 and the third-party data 108. Typically, some of the input data is in structured format and of some of the input data is in unstructured format. Unstructured data may be represent data in different formats, and not in one particular format readable by the product promotion system 102. In an example, unstructured data may include data in different formats including e-mail messages, word processing documents, videos, photos, audio files, presentations, webpages and many other kinds of business documents.

To have the input data in the structured format, the data harmonization module 116 perform operations to harmonize the structured and unstructured data into a particular format compatible with the product promotion system 102. The data format used by the product promotion system 102 may be any format, which would be obvious to a person skilled in the art. In an example, the data harmonization module 116 may perform harmonization using a master template, and incorporating both the structured and unstructured data in the master template format.

Once the input data is harmonized and converted into a particular format, the data cleanser module 118 may receive the data from the data harmonization module 116. It may be noted that in a different embodiment, the data can be cleansed before harmonization. The data cleanser module 118 may use commonly known data cleansing algorithms. In an example, the data cleanser module 118 may identify any missing data in the input data. Once the missing data is identified, the data cleanser module 118 may map the missing data to a pattern of historical data available, and then replace the missing data with mean/median value of the pattern.

Upon obtaining harmonized and cleansed data, the feature selection module 120 may identify training data by analyzing the harmonized and cleansed data based on one or more linearity factors. The training data may be then used for determining an optimal model for promotion effectiveness at a product level.

In an example, the feature selection module 120 may split the input data into raw training data and raw testing data. The split can be in the ratio of 80% for training data, and 20% for testing data. It may be noted that the ratio mentioned here is indicative, and any other ratio can also be used.

Further, the feature selection module 120 may process the training data for standard regression checks of data linearity, multivariate normality & multicollinearity evaluation, collectively referred to as the one or more linearity factors. In an example, the feature selection module 120, may check whether the relationship between the independent and dependent variables is linear for performing supervised learning. The linear regression analysis may require all variables to be multivariate normal i.e. the training data needs to be normally distributed. The feature selection module 120 may transform the data to make it linear. If there is any issue with linearity, or if the price elasticity is very high, then the feature selection module 120 may transform the different variables to a log scale, example of which is given in the following section.

Once the training data is obtained, the feature selection module 120 may create a plurality of feature sets based on the training data. The plurality of feature sets may be understood as unique combinations of sales parameters. The sales parameters may be understood as significant features in the training data that may potentially impact the sales volume Examples of the sales parameter may include price of a product, discounts, free quantity, display units, season, holidays, displays or advertising. In an example, a unique combination of the sales parameters is expressed in Equation 1.

ln(Sales Volume)˜ln(Price)+(Discount)+(FreeQuantity)+Display) Equation 1

Thereafter, the feature selection module may select an optimized feature set from the plurality of feature sets based on the regression model. In an example, a feature set with a maximum coefficient of determinant may be selected as the optimized feature set.

Once the optimized feature set is selected from the plurality of feature sets, the uplift modeler 122 may create an uplift model for each of the products based on the optimized feature set. In an example, the uplift model may be expressed as shown in Equation 2:

ln Y=ln(α)+β₁ ln X₁+β₂ ln X₂+β₃ ln X₃+β₄ ln X₄+β₅ ln X₅+ε Equation 2

Where:
Y=Sales volume;
Xi=Features that affect sales volume;
β=Degrees of responses due to changes in the associated variables

The uplift model may be used to calculate uplift volume, by the uplift modeler 122. In an example, the uplift modeler 122 may calculate the uplift volume based on a baseline volume and a predictive module. The uplift modeler 122 may subtract the baseline volume from the predictive volume to obtain the uplift volume.

In an example, to calculate the predictive volume, the uplift modeler 122, may identify trend data of the based on actual sales volume of a product, over a predefined period of time. The trend data may be termed as FIT 1.

Subsequently, the uplift modeler 122 may apply a first order regression model to the trend data to obtain de-trended data. The de-trended data (Sales Volume-Trend) may then be regressed against the optimized feature set and impact of known causals are determined. The uplift modeler 122 may save the output, referred to as FIT2, of the regression in the form of metadata in the database 106.

Further, the uplift modeler 122 may further determine impact of unknown causals. In an example, the residuals (unknown variables) from the regression model done to evaluate the impact of known causals, may be modelled using time series AutoRegressive Integrated Moving Average (ARIMA) models with the best ARIMA model dependent on the stationarity exhibited by the data. The Uplift modeler 122 maybe be equipped with an automated modeler to capture the best ARIMA model suited to make the data more stationary. The ARIMA output from the model is defined as FIT 3, which forms a model correction factor and may be stored in the database 106.

In another example, the residuals may be modeled using Classification and Regression tree where a number may be associated to a particular week of the year or month and the number and the residual value may form the inputs to the model.

The model created for evaluating the predictive volume for a particular product may be represented as the summation of FIT1+FIT2+FIT3 or as shown in Equation 3.

ln(Sales Volume)=α+β1*Price β2*PromotionalCausal1+β3*PromotionalCausal2+ . . . +βn*PromotionalCausaln+μ1*FIT2ᵢ+μ2*FIT3ᵢ+ε Equation 3

Where:
α=Intercept for fixed effect
i=Period
ε=Residual Error Term of the model

Further, to determine the baseline volume, the uplift modeler 122 may calculate a threshold price for any particular product based on a price elasticity model. The threshold price then maybe compared with each recorded price data, to identify promotional threshold value. The promotional threshold value is the value, below which the price is considered a promotional price and the price if promotional may then be replaced with the previous non-promotional price or maximum price. All the other marketing/promotion causals value maybe substituted with 0 for Baseline Volume calculation. The baseline volume equation maybe of the form as shown in Equation 4:

ln(Sales Volume)=α+β1*Base Price+μ1*FIT2ᵢ+μ2*FIT3ᵢ+ε Equation 4

Where:
α=Intercept for fixed effect
i=Period
ε=Residual Error Term of the model

In an example, the uplift volume maybe calculated by subtracting the baseline volume from the predictive volume. The uplift volume may then be stored in the database 106.

The data validation module 124 may use the test data demarcated by the feature selection module 120 for validating the prediction algorithm based on the validation parameters like coefficient of determination and mean forecast error.

In an example, the data validation module 124 may analyze the regression coefficients and the predicted uplift model based on the test data. The result of the analysis may then be used for determining a mean forecast error. Thereafter, the data validation module 124 may use the mean forecast error to evaluate the uplift model obtained for the products.

The cannibalization coefficient generator 126 may generate cannibalization coefficient for an aggressor product and victim product combination and the output maybe stored in the database 106 for further consumption. The victim product may be products whose sales volume may decline because of promotion of a particular product or the aggressor product. The cannibalization coefficient determination equation maybe of the form as shown in Equation 5:

Sales Volume_{(Aggressor Product)}=a+β1*Uplift Volume_{(victim product)} Equation 5

Where:
a=Base Volume of Aggressor Product
β1=Cannibalization Coefficient

In an example, the cannibalization coefficient generator 126 may regress sales volume of an aggressor product, against the uplift volume of a victim product and determine the cannibalization coefficient.

In another example, the cannibalization coefficient may be calculated, where the victim or the aggressor product is not specified. The cannibalization coefficient generator 126, may regress sales volume of the aggressor product against the uplift volume of the victim product for all aggressor product and victim product combinations to form a cannibalization coefficient matrix. The cannibalization coefficient generator 126 may then select only those cannibalization coefficients from the cannibalization coefficient matrix, which show significant trend, that is significant change in sales volume of the victim product because of the aggressor product promotion, and may determine their value at three different price segments. The three different price segments may be Segment a, segment b and segment c, where the segment a ranges from 0 to median of promotion price, and where promotion price is the price range from 0 to the threshold price. Segment b may be the price segment between the median and the threshold price, and segment c may be the price segment between the threshold price and the maximum price, that is the price range when no promotion activity has taken place.

In another example, the cannibalization coefficient may be calculated, where the victim product and the aggressor product is specified. The cannibalization coefficient generator 126, may then regress sales volume of the aggressor product against the uplift volume of the victim product for the specified combination at the three price segments and store them for further consumption in the database 106.

The promotion data generation engine 128 may calculate return on investment and effectiveness of the promotions using the product level uplift models, with the data stored in the database 106.

In an example, the promotion data generation engine 128, may calculate the promotion data or return on investment of a particular promotional campaign for a particular product, making use of the standard marketing return on investment calculation methods based on promotional expenditure data, which is the amount spent or invested for the promotional campaigns and the uplift volume as inputs. The return on investment may be an effective data, to find the effectiveness of the promotional activity, or the change in sales of the product for which the promotion may have been run. A negative change in the sales shows the negative impact of promotion, while a positive change shows the effectiveness of the promotion.

In another example, the promotion data generation engine 128, may use the uplift volume and the at least one cannibalization coefficient for calculating the promotion data, or return on investment of a particular promotional campaign for a particular product. In another example, the promotion data generation engine 128 may consider pantry loading effect as well while generating the promotion data.

Thus, the system 102 disclosed in the present subject matter generates the promotion data at a product level. The system 102 employs a unique and efficient way of calculating the uplift volume which is then used for generating the promotion data. Apart from known causals, the system 102 considers impact of unknown causals as well while determining the uplift volume. The promotion data generated by the 102 system gives an accurate indication of effectiveness of a program.

The methods 200, 300 and 400 may be described in the general context of computer executable instructions. Generally, computer executable instructions can include routines, programs, objects, components, data structures, procedures, modules, and functions, which perform particular functions or implement particular abstract data types. The methods 200, 300 and 400 may also be practiced in a distributed computing environment where functions are performed by remote processing devices that are linked through a communication network. In a distributed computing environment, computer executable instructions may be located in both local and remote computer storage media, including memory storage devices.

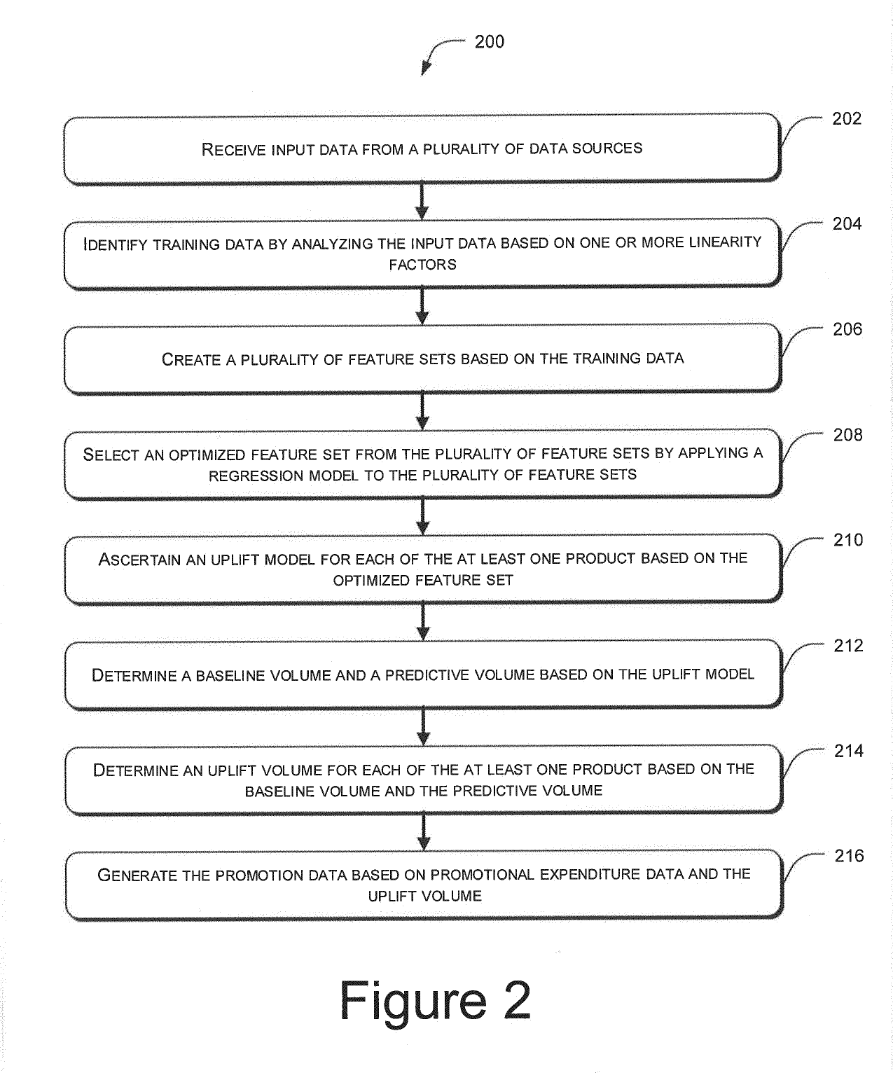

Reference is made to FIGS. 2, 3, and 5, the order in which the methods 200, 300 and 400 are described is not intended to be construed as a limitation, and any number of the described method blocks can be combined in any order to implement the methods 200, 300 and 400 or alternative methods. Additionally, individual blocks may be deleted from the methods 200, 300 and 400 without departing from the spirit and scope of the subject matter described herein. Furthermore, the methods 200, 300 and 400 can be implemented in any suitable hardware, software, firmware, or combination thereof.

FIG. 2 illustrates an exemplary method for generating promotion data for a particular product, in accordance with some embodiments of the present disclosure.

With reference to FIG. 2, at block 202, input data is received from the data source(s) 104. In an example, the input data comprises the manufacturer data 112, the retailer data 110, and third party data 108. The manufacturer data 112 may comprise historical sales data obtained from one or more stores selling the at least one product and promotion planning data planned for previous promotional activities and current promotional activity. The retailer data 110 may comprise point-of-sales data from the one or more stores. The third party data 108 may comprise details of competitor products.

In an example, the data collection module 114 module may access the data source(s) 104 to obtain the input data. The data source(s) 104 may be understood as repositories maintained by companies to store details for product promotions and sales, information available in public domain pertaining to various products, and repositories maintained by market analytics companies.

At block 204, training data is identified by analyzing the input data based on one or more linearity factors. In an example, the input data is received by the data harmonization module 116 to harmonize the input data into a format compatible with the system 102. After harmonizing, the data cleanser module 118 may remove the noise from the data and identify if there is any missing data. In an example, the data cleanser module 118 may map the missing data with a pattern of historical data to fill in missing data in the input data.

In an example, the feature selection module 120 may not take entire set of the input data. The feature selection module 120 may split the input data into raw training data and testing data. The feature selection module 120 may consider only the raw training data for generating the promotion data and use the testing data for validating the promotion data. Further, the feature selection module 120 may process the raw training data based on data linearity, multivariate normality or multicollinearity to obtain the training data. Further, the training data may be understood as data obtained after harmonizing and cleansing the input data.

At block 206, a plurality of feature sets are created based on the training data. Each of the plurality of feature sets is a unique combination of sales parameters. Examples of the sales parameters may include price of the at least one product, seasonality, discounts, free quantity, and display units. In an example, the feature selection module 120 may select the one or more sales parameters by analyzing the input data and create unique combinations of the sales parameters to obtain the plurality of feature sets. In an example, each of the plurality of feature sets may be defined by a first order or polynomial terms (up to 2^{nd} order) per the requirement and also to achieve a maximum coefficient of determinant value.

At block 208, an optimized feature set from the plurality of feature sets is selected by applying a regression model to the plurality of feature sets. The optimized feature set is a feature set, selected from the plurality of feature sets, with the maximum coefficient of determinant value. In an example, the feature selection module 120 may apply the regression model to the plurality of features sets using predictor variable sales to identify the optimized feature set. Thereafter, the optimized feature set may be used for model creation.

At block 210, an uplift model for each of the at least one product is ascertained based on the optimized feature set. In an example, the uplift modeler 122 may determine the uplift model for each of the products based on the optimized feature set. Further, the data validation module 124 may analyze regression coefficients and the uplift model based on the testing data to determine a mean forecast error. Thereafter, the data validation module 124 may use the mean forecast error to evaluate the uplift model obtained for the products.

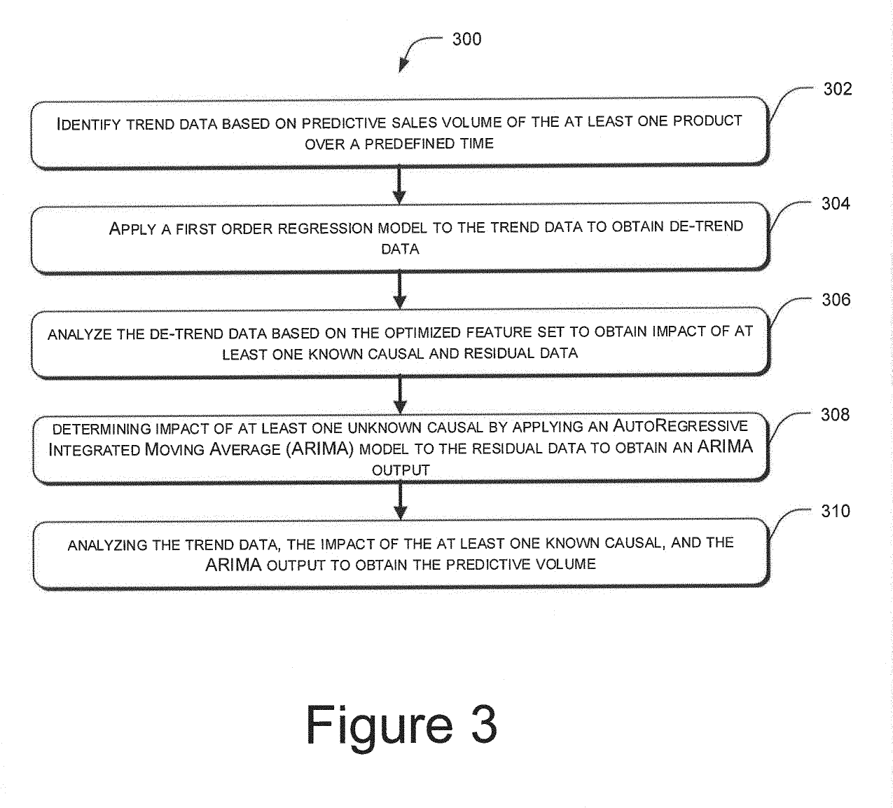

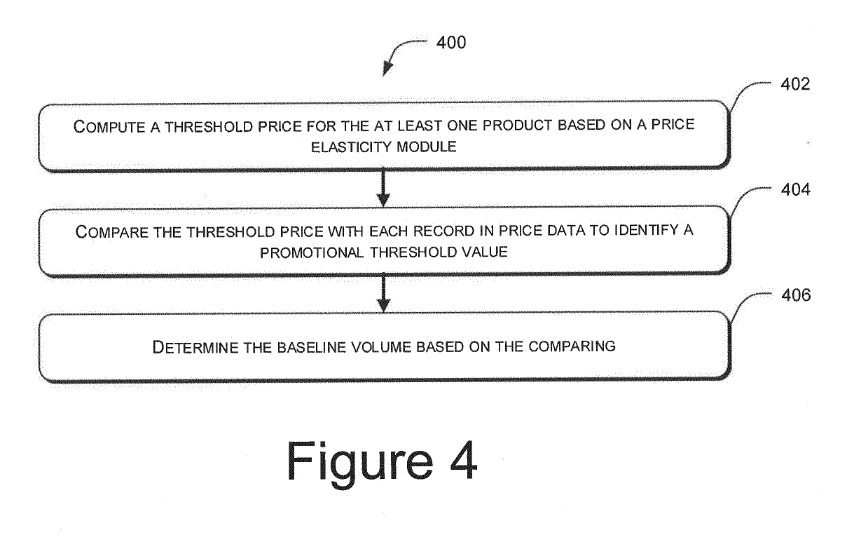

At block 212, a baseline volume and a predictive volume are determined based on the uplift model. In an example, the uplift modeler 122 may determine the baseline volume and the predictive volume based on the uplift model. Computation of the predictive volume and the baseline volume is discussed in detail in conjunction with FIG. 3 and FIG. 4, respectively.

At block 214, an uplift volume for each of the at least one product is determined based on the baseline volume and the predictive volume. In an example, the uplift modeler 122 may determine the uplift volume by subtracting the baseline volume from the predictive volume.

At block 216, the promotion data is generated based on promotional expenditure data and the uplift volume. In an example, the promotion data generation engine 128 may generate the promotion data by comparing the uplift volume with the expenditure data. The expenditure data may indicate return on investment (ROI) for various promotional campaigns that are running for the at least one product.

In an example, the promotion data generation engine 128 may consider sales volume and promotional campaigns of competitor products and products suffering a decline in sales (victim product) due to promotional campaigns of the at least one product (aggressor product) to generate the promotion data. The cannibalization coefficient generator 126, may determine at least one cannibalization coefficient. In an example, to determine the cannibalization coefficient, the cannibalization coefficient generator 126 may regress sales volume of an aggressor product, against the uplift volume of a victim product and determine the cannibalization coefficient.

In another example, the cannibalization coefficient generator 126 may regress sales volume of an aggressor product, against the uplift volume of a victim product, for all the aggressor product and the victim product combinations, when the aggressor product and the victim product combination is not mentioned and only a specific combination when mentioned and may determine the cannibalization coefficient at three different price segments. The three different price segments may be Segment a, segment b and segment c, where the segment a ranges from 0 to median of promotion price, and where promotion price is the price range from 0 to the threshold price. Segment b may be the price segment between the median and the threshold price, and segment c may be the price segment between the threshold price and the maximum price, that is the price range when no promotion activity has taken place

In an example, the promotion data may include details to indicate effectiveness of promotional campaigns for the products. Examples of such details may include uplift in sales of the products, increased ROI, increase in market presence of the products, and increase in demand of the products.

FIG. 3 illustrates an exemplary method generating predictive volume, in accordance with some embodiments of the present disclosure.

At block 302, trend data is identified based on actual sales volume of the at least one product over a predefined time. In an example, the uplift modeler 122 may model the predictive sales volume starting with a time series decomposition exercise by identifying a linear trend of the data. Further, the uplift modeler 122 may remove impact of the linear trend from raw sales data to be used for further prediction.

At block 304, a first order regression model is applied to the trend data to obtain de-trend data. In an example, the uplift modeler 122 may apply the first order regression model to the trend data to obtain the de-trend data.

At block 306, the de-trend data is analyzed based on the optimized feature set to obtain at least one known causal. In an example, the uplift modeler 122 may regress the de-trend data against the optimized feature set to identify the at least one known casual and the impact of the at least known one causal. Further, the uplift modeler 122 may store metadata of coefficients generated during regression in the database 106 for future reference.

At block 308, impact of the at least one unknown causal is determined based on an AutoRegressive Integrated Moving Average (ARIMA) model to obtain an ARIMA output. In an example, the uplift modeler 122 may determine the impact of the unknown causals based on the ARIMA model. Further, based on the impact, the uplift modeler 122 determines the ARIMA output which acts as a model correction factor and is equated to a time period and stored in the database 106.

At block 310, the trend data, the impact of the at least one known causal, and the ARIMA output are analyzed to obtain the predictive volume. In an example, the uplift modeler 122 may aggregate the trend data, the impact of the at least one known causal, and the ARIMA output to obtain the predictive volume.

FIG. 4 illustrates an exemplary method generating baseline volume, in accordance with some embodiments of the present disclosure.

At block 402, a threshold price for the at least one product is computed based on a price elasticity model. In an example, the uplift modeler 122 may calculate a threshold volume, which is the median of sales volume data when no promotions are being run. The threshold volume may form the target to the price elasticity model and the model (fitness function) is then subjected to a linear optimization by the uplift modeler 122 to calculate the threshold price.

At block 404, the threshold price is compared with each record in price data to identify a promotional threshold value. In an example, the uplift modeler 122 may identify a threshold below which the price is considered a promotional price and if the price is promotional, it may be then be replaced with the previous non-promotional price or maximum price to determine the threshold price.

At block 406, the baseline volume is determined based on the comparing. In an example, the uplift modeler 122 may determine the baseline volume by considering marketing/promotion causals value to be zero.

### Computer System

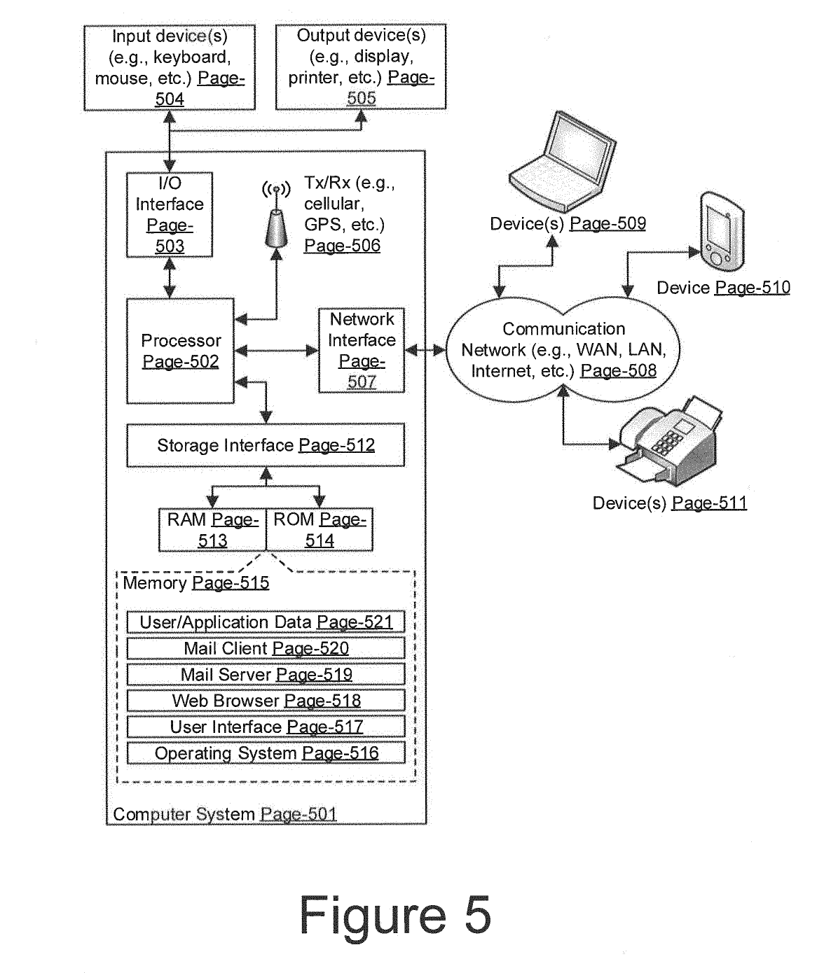

FIG. 5 is a block diagram of an exemplary computer system for implementing embodiments consistent with the present disclosure. Variations of computer system 501 may be used for implementing the modules/components of the product promotion system 102 presented in this disclosure. Computer system 501 may comprise a central processing unit (“CPU” or “processor”) 502. Processor 502 may comprise at least one data processor for executing program components for executing user- or system-generated requests. A user may be a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Optero, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 510, 511, and 512. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE). IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501 such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described systems and methods for generating promotion data for products. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored, Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for generating promotion data pertaining to at least one product, wherein the method comprises:
receiving, by a product promotion system, input data from a plurality of data sources, wherein the input data comprises at least one of manufacturer data, retailer data or third-party data;
identifying, by the product promotion system, training data by analyzing the input data based on one or more linearity factors;
creating, by the product promotion system, a plurality of feature sets based on the training data, wherein each of the plurality of feature sets is a unique combination of sales parameters;
selecting, by the product promotion system, an optimized feature set from the plurality of feature sets by applying a regression model to the plurality of feature sets;
ascertaining, by the product promotion system, an uplift model for each of the at least one product based on the optimized feature set;
determining, by the product promotion system, a baseline volume and a predictive volume based on the uplift model;
determining, by the product promotion system, an uplift volume for each of the at least one product based on the baseline volume and the predictive volume; and
generating, by the product promotion system, the promotion data based on promotional expenditure data and the uplift volume.

2. The method of claimed 1, wherein the manufacturer data comprises historical sales data obtained from one or more stores selling the at least one product and promotion planning data planned for previous promotional activities and current promotional activity, wherein the retailer data comprises point-of-sales data from the one or more stores, and wherein the third-party data comprises details of competitor products.

3. The method of claim 1, wherein identifying the training data further comprises:
splitting the input data into raw training data and testing data; and
processing the raw training data based on at least one of data linearity, multivariate normality or multicollinearity to obtain the training data.

4. The method of claim 3, wherein ascertaining the uplift model for each of the at least one product further comprises:
analyzing regression coefficients and the uplift model based on the testing data;
determining a mean forecast error based on the analyzing; and
evaluating the uplift model based on the mean forecast error.

5. The method of claim 1, wherein the sales parameters comprises at least one of a price of the at least one product code, seasonality, discounts, free quantity, or display units.

6. The method of claim 1, wherein the optimized feature set is a feature set, selected from the plurality of feature sets, with a maximum coefficient of determination obtained based on the regression model.

7. The method of claim 1, wherein determining the predictive volume further comprises:
identifying trend data based on actual sales volume of the at least one product over a predefined time;
applying a first order regression model to the trend data to obtain de-trend data;
analyzing the de-trend data based on the optimized feature set to obtain impact of at least one known causal and residual data;
determining impact of at least one unknown causal by applying an AutoRegressive Integrated Moving Average (ARIMA) model to the residual data to obtain an ARIMA output; and
analyzing the trend data, the impact of the at least one known causal, and the ARIMA output to obtain the predictive volume.

8. The method of claim 1, wherein determining the baseline volume further comprises:
computing a threshold price for the at least one product based on a price elasticity model;
comparing the threshold price with each record in price data to identify a promotional threshold value; and
determining the baseline volume based on the comparing.

9. The method of claim 1, wherein generating the promotion data further comprises:
determining, by the product promotion system, at least one cannibalization coefficient, wherein sales volume of an aggressor product, is regressed against the uplift volume of a victim product, further wherein the victim product is a product whose sales volume may decline because of promotion of the at least one product and the aggressor product is the at least one product; and
generating, by the product promotion system, the promotion data based on promotional expenditure data, the uplift volume and the at least one cannibalization coefficient, wherein the promotion data comprises change in sales of the at least one product.

10. A system for generating promotion data pertaining to at least one product, the system comprising:
at least one processor; and
a computer-readable medium storing instructions that, when executed by the at least one processor, cause the at least one processor to perform operations comprising:
receiving input data from a plurality of data sources, wherein the input data comprises at least one of manufacturer data, retailer data or third-party data;
identifying training data by analyzing the input data based on one or more linearity factors;
creating a plurality of feature sets based on the training data, wherein each of the plurality of feature sets is a unique combination of sales parameters;
selecting an optimized feature set from the plurality of feature sets by applying a regression model to the plurality of feature sets;
ascertaining an uplift model for each of the at least one product based on the optimized feature set;
determining a baseline volume and a predictive volume based on the uplift model;
determining an uplift volume for each of the at least one product based on the baseline volume and the predictive volume; and
generating the promotion data based on promotional expenditure data and the uplift volume.

11. The system of claim 10, wherein the manufacturer data comprises historical sales data obtained from one or more stores selling the at least one product and promotion planning data planned for previous promotional activities and current promotional activity, wherein the retailer data comprises point-of-sales data from the one or more stores, and wherein the third-party data comprises details of competitor products.

12. The system of claim 10, wherein identifying the training data further comprises:
splitting the input data into raw training data and testing data; and
processing the raw training data based on at least one of data linearity, multivariate normality or multicollinearity to obtain the training data.

13. The system of claim 12, wherein ascertaining the uplift model for each of the at least one product further comprises:
analyzing regression coefficients and the uplift model based on the testing data;
determining a mean forecast error based on the analyzing; and
evaluating the uplift model based on the mean forecast error.

14. The system of claim 10, wherein the sales parameters comprises at least one of a price of the at least one product code, seasonality, discounts, free quantity, or display units.

15. The system of claim 10, wherein the optimized feature set is a feature set, selected from the plurality of feature sets, with a maximum coefficient of determination obtained based on the regression model.

16. The system of claim 10, wherein determining the predictive volume further comprises:
identifying trend data based on actual sales volume of the at least one product over a predefined time;
applying a first order regression model to the trend data to obtain de-trend data;
analyzing the de-trend data based on the optimized feature set to obtain impact of at least one known causal and residual data;
determining impact of at least one unknown causal by applying an AutoRegressive Integrated Moving Average (ARIMA) model to the residual data to obtain an ARIMA output; and
analyzing the trend data, the impact of the at least one known causal, and the ARIMA output to obtain the predictive volume.

17. The system of claim 10, wherein determining the baseline volume further comprises:
computing a threshold price for the at least one product based on a price elasticity model;
comparing the threshold price with each record in price data to identify a promotional threshold value; and
determining the baseline volume based on the comparing.

18. The system of claim 10, wherein generating the promotion data further comprises:
determining, by the product promotion system, at least one cannibalization coefficient, wherein sales volume of an aggressor product, is regressed against the uplift volume of a victim product, further wherein the victim product is a product whose sales volume may decline because of promotion of the at least one product and the aggressor product is the at least one product; and
generating, by the product promotion system, the promotion data based on promotional expenditure data, the uplift volume and the at least one cannibalization coefficient, wherein the promotion data comprises change in sales of the at least one product.

19. A non-transitory computer-readable medium storing instructions for generating promotion data pertaining to at least one product, wherein upon execution of the instructions by one or more processors, the processors perform operations comprising:
receiving input data from a plurality of data sources, wherein the input data comprises at least one of manufacturer data, retailer data or third-party data;
identifying training data by analyzing the input data based on one or more linearity factors;
creating a plurality of feature sets based on the training data, wherein each of the plurality of feature sets is a unique combination of sales parameters;
selecting an optimized feature set from the plurality of feature sets by applying a regression model to the plurality of feature sets;
ascertaining an uplift model for each of the at least one product based on the optimized feature set;
determining a baseline volume and a predictive volume based on the uplift model;
determining an uplift volume for each of the at least one product based on the baseline volume and the predictive volume; and
generating the promotion data based on promotional expenditure data and the uplift volume.

20. The medium of claim 19, wherein ascertaining the uplift model for each of the plurality of products further comprises:
analyzing regression coefficients and the uplift model based on the testing data;
determining a mean forecast error based on the analyzing; and
evaluating the uplift model based on the mean forecast error.

21. The medium of claim 19, wherein determining the predictive volume further comprises:
identifying trend data based on actual sales volume of the at least one product over a predefined time;
applying a first order regression model to the trend data to obtain de-trend data;
analyzing the de-trend data based on the optimized feature set to obtain impact of at least one known causal and residual data;
determining impact of at least one unknown causal by applying an AutoRegressive Integrated Moving Average (ARIMA) model to the residual data to obtain an ARIMA output; and
analyzing the trend data, the impact of the at least one known causal, and the ARIMA output to obtain the predictive volume.

22. The medium of claim 19, wherein determining the baseline volume further comprises:
computing a threshold price for the at least one product based on a price elasticity model;
comparing the threshold price with each record in price data to identify a promotional threshold value; and
determining the baseline volume based on the comparing.

23. The medium of claim 19, wherein generating the promotion data further comprises:
determining, by the product promotion system, at least one cannibalization coefficient, wherein sales volume of an aggressor product, is regressed against the uplift volume of a victim product, further wherein the victim product is a product whose sales volume may decline because of promotion of the at least one product and the aggressor product is the at least one product; and
generating, by the product promotion system, the promotion data based on promotional expenditure data, the uplift volume and the at least one cannibalization coefficient, wherein the promotion data comprises change in sales of the at least one product.
